(19) United States
(12) Patent Application Publication
(10) Pub. No.: US 2026/0079562 A1
(43) Pub. Date: Mar. 19, 2026

(54) Temperature-Based Voltage Margin Control

(71) Applicant: Apple Inc., Cupertino, CA (US)

(72) Inventors: Angel E. Socarras, Orlando, FL (US); Benoit M. Jubelin, Austin, TX (US); Vivek Oppula, Lakeway, TX (US)

(21) Appl. No.: 19/039,002

(22) Filed: Jan. 28, 2025

Related U.S. Application Data
(60) Provisional application No. 63/696,724, filed on Sep. 19, 2024.

(51) Int. Cl. G06F 1/3296; G06F 1/3206; G06F 1/3234

(52) U.S. Cl. CPC G06F 1/3296; G06F 1/3206; G06F 1/3243

(57) ABSTRACT

In disclosed embodiments, a voltage sensor of a computing device is configured to determine a voltage level of a supply voltage provided by a power supply to processor circuitry. Comparator circuitry may perform a comparison operation that compares the determined voltage level to a threshold. A temperature sensor may determine a temperature of at least a portion of processor circuitry. Power control circuitry may initiate a power management operation to adjust voltage margin based on a result of the comparison operation. Additionally, the power management circuitry may control the comparator circuitry to impose an offset on the comparison operation. The power control circuitry may determine a magnitude of the offset based on a pre-determined effect of the determined temperature on voltage margin parameters for at least a portion of the processor circuitry.

### CROSS REFERENCE TO RELATED APPLICATIONS

The present application claims priority to U.S. Provisional App. No. 63/696,724 entitled “Temperature-Based Voltage Margin Control,” filed Sep. 19, 2024, the disclosure of which is incorporated by reference herein in its entirety.

### BACKGROUND

### Technical Field

This disclosure relates generally to power control for computing devices and more particularly to techniques for accounting for thermal effects on the operation of the computing device.

### Description of Related Art

Various components of an integrated circuit (IC) die of a system-on-a-chip (SOC) receive one or more supply voltages from a power supply. Typically, power control circuitry regulates the power supply to provide the supply voltage at a fixed or programmable level. Power management of the SOC typically monitors various operating conditions (e.g., which components are operating in what performance state, supply voltage measurements, etc.) and may initiate power control actions under certain conditions (e.g., to adjust performance states, control clock frequency, etc.). This may include taking remedial actions in response to droops in the supply voltage. Generally, an SOC may be managed by power management circuitry to balance performance and power consumption. The SOC may maintain a voltage margin (e.g., between the supply voltage and required voltage) to reduce or prevent computing errors and equipment damage.

### BRIEF DESCRIPTION OF DRAWINGS

FIG. 1A is a diagram illustrating an overview of example graphics processing operations, according to some embodiments.

FIG. 1B is a block diagram illustrating an example graphics unit, according to some embodiments.

FIG. 2 is a block diagram illustrating power control circuitry configured to impose an temperature-based offset on a comparison operation for power management, according to some embodiments.

FIG. 3 is a block diagram illustrating example application and rounding for multiple different offsets to adjust a threshold value based on temperature, according to some embodiments.

FIG. 4 illustrates example control based on localized temperature measurements, according to some embodiments.

FIG. 5 is a block diagram illustrating example power control circuitry with adaptive margin control, according to some embodiments.

FIG. 6A illustrates an example look-up table with temperature-adjusted voltage margin offset values, according to some embodiments.

FIG. 6B illustrates an example look-up table with temperature-adjusted voltage sensor offset values, according to some embodiments.

FIG. 7 is a block diagram illustrating example direct memory access (DMA) control circuitry configured to access a lookup table based on a temperature measurement, according to some embodiments.

FIG. 8 is a flow diagram illustrating an example method, according to some embodiments.

FIG. 9 is a block diagram illustrating an example computing device, according to some embodiments.

FIG. 10 is a diagram illustrating example applications of disclosed systems and devices, according to some embodiments.

FIG. 11 is a block diagram illustrating an example computer-readable medium that stores circuit design information, according to some embodiments.

### DETAILED DESCRIPTION

Power control circuitry may control various aspects of a system (e.g., an SOC) based on various monitored operating conditions. For example, the power control circuitry may monitor or control performance state, clock frequency, voltage levels, clock gating, component operating state, etc. Power control circuitry may initiate corrective actions when the supply voltage falls below an operating threshold, e.g., as detected by voltage sensors. The power control circuitry may also control the supply voltage to provide voltage margin (additional voltage above what is currently needed, e.g., to mitigate potential high current draw events). The control circuitry may attempt to keep the voltage margin within reasonable levels to reduce power consumption. Example adaptive voltage margin control is discussed in U.S. patent application Ser. No. 18/394,997, entitled “Adaptive Voltage Margin Techniques,”and filed on Dec. 22, 2023, for example.

Various aspects of the system may be affected by temperature. For example, as the temperature of the silicon substrate from which the integrated circuit die is fabricated increases, data processing speed of the components of the integrated circuit (IC) die may be impacted, which may impact target voltage margins. Additionally, voltage sensors may behave non-linearly with respect to temperature. Therefore, in disclosed embodiments, power control circuitry is configured to account for temperature effects in its power management decisions. For example, when determining to initiate a power control action, such as requesting a supply voltage increase, the power control circuitry may implement a temperature-based margin offset, a temperature-based voltage sensor offset, or both. This may advantageously improve the power control circuitry's ability to meet performance targets and reduce power consumption while maintaining acceptable voltage margin.

Specifically, in disclosed embodiments, comparator circuitry of an integrated circuit die is configured to perform a comparison to compare a voltage level determined by a voltage sensor with a threshold value. The threshold value may be a target voltage level. Power control circuitry is configured to initiate corrective action in response to the comparator circuitry indicating that the determined voltage level meets (e.g., drops below) the threshold. The power control circuitry is further configured to control the comparator circuitry to impose a temperature-based offset on the comparison. The amount of the offset may be based on one or more temperature measurements. The offset may include multiple components, e.g., a first value that corresponds to a voltage margin adjustment for the components of the integrated circuit die at the measured temperature and a second offset. that corresponds to an amount of temperature-induced non-linearities in operation of the voltage sensor.

In some embodiments, temperature sensors distributed throughout an SOC may be used to perform local adjustments (e.g., adjustments that target certain voltage sensors or voltage margin associated with specific components). When comparing one or more operating parameters (e.g., sensor measurements) to a threshold value, the power control circuitry may apply the temperature-based offset to the threshold value rather than to the operating parameter, which may reduce complexity and power consumption associated with applying the offset (e.g., due to infrequent changes in the threshold value as compared with the voltage measurements).

In some embodiments, the power control circuitry is configured to adaptively adjust the requested supply voltage, within an operating state of the processor circuitry, between a voltage floor and a voltage ceiling. This may dynamically adjust voltage margin to improve performance and power consumption. For example, power control circuitry may start at or near the voltage ceiling (which may be determined based on performance states of one or more components) and iteratively reduce the requested supply voltage until the voltage floor is detected (e.g., by one or more voltage sensors). Therefore, the voltage floor or the voltage ceiling may correspond to the threshold value. Hence, measured voltage may be compared with one or both of these parameters.

As one example implementation, the power control circuitry may implement a look-up table that includes temperature-based offsets. The power control circuitry may implement separate tables for separate considerations (e.g., one table for voltage margin adjustments and another table for voltage sensor adjustments). Each entry may include a range of temperatures and a corresponding offset. Note that the range of temperature values for an entry may be selected to cover an expected maximum drift in temperature over a time interval (e.g., such that the power control circuitry can detect and mitigate any excursions as fast as the temperature can change). In embodiments that add multiple temperature-based offsets to a threshold, control circuitry may add all of the offsets to the threshold prior to rounding.

### Graphics Processing Overview

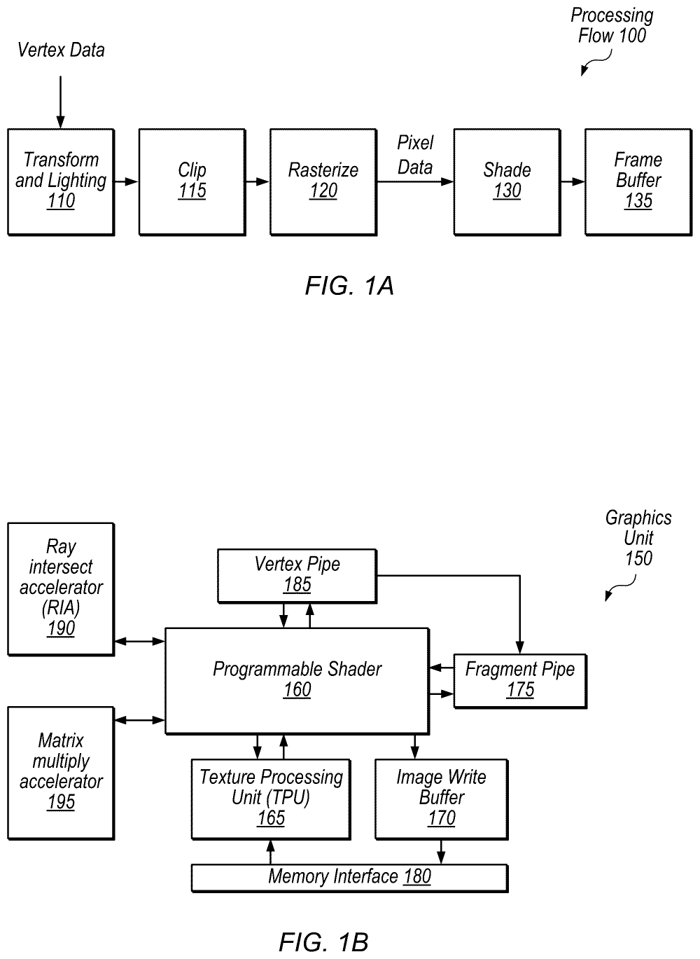

Referring to FIG. 1A, a flow diagram illustrating an example processing flow 100 for processing graphics data is shown. In some embodiments, transform and lighting procedure 110 may involve processing lighting information for vertices received from an application based on defined light source locations, reflectance, etc., assembling the vertices into polygons (e.g., triangles), and transforming the polygons to the correct size and orientation based on position in a three-dimensional space. Clip procedure 115 may involve discarding polygons or vertices that fall outside of a viewable area. In some embodiments, geometry processing may utilize object shaders and mesh shaders for flexibility and efficient processing prior to rasterization. Rasterize procedure 120 may involve defining fragments within each polygon and assigning initial color values for each fragment, e.g., based on texture coordinates of the vertices of the polygon. Fragments may specify attributes for pixels which they overlap, but the actual pixel attributes may be determined based on combining multiple fragments (e.g., in a frame buffer), ignoring one or more fragments (e.g., if they are covered by other objects), or both. Shade procedure 130 may involve altering pixel components based on lighting, shadows, bump mapping, translucency, etc. Shaded pixels may be assembled in a frame buffer 135. Modern GPUs typically include programmable shaders that allow customization of shading and other processing procedures by application developers. Thus, in various embodiments, the example elements of FIG. 1A may be performed in various orders, performed in parallel, or omitted. Additional processing procedures may also be implemented.

Referring now to FIG. 1B, a simplified block diagram illustrating a graphics unit 150 is shown, according to some embodiments. In the illustrated embodiment, graphics unit 150 includes programmable shader 160, vertex pipe 185, fragment pipe 175, texture processing unit (TPU) 165, image write buffer 170, and memory interface 180. In some embodiments, graphics unit 150 is configured to process both vertex and fragment data using programmable shader 160, which may be configured to process graphics data in parallel using multiple execution pipelines or instances.

Vertex pipe 185, in the illustrated embodiment, may include various fixed-function hardware configured to process vertex data. Vertex pipe 185 may be configured to communicate with programmable shader 160 in order to coordinate vertex processing. In the illustrated embodiment, vertex pipe 185 is configured to send processed data to fragment pipe 175 or programmable shader 160 for further processing.

Fragment pipe 175, in the illustrated embodiment, may include various fixed-function hardware configured to process pixel data. Fragment pipe 175 may be configured to communicate with programmable shader 160 in order to coordinate fragment processing. Fragment pipe 175 may be configured to perform rasterization on polygons from vertex pipe 185 or programmable shader 160 to generate fragment data. Vertex pipe 185 and fragment pipe 175 may be coupled to memory interface 180 (coupling not shown) in order to access graphics data.

Programmable shader 160, in the illustrated embodiment, is configured to receive vertex data from vertex pipe 185 and fragment data from fragment pipe 175 and TPU 165. Programmable shader 160 may be configured to perform vertex processing tasks on vertex data which may include various transformations and adjustments of vertex data. Programmable shader 160, in the illustrated embodiment, is also configured to perform fragment processing tasks on pixel data such as texturing and shading, for example. Programmable shader 160 may include multiple sets of multiple execution pipelines for processing data in parallel.

In some embodiments, programmable shader 160 includes pipelines configured to execute one or more different SIMD groups in parallel. Each pipeline may include various stages configured to perform operations in a given clock cycle, such as fetch, decode, issue, execute, etc. The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

The term “SIMD group” is intended to be interpreted according to its well-understood meaning, which includes a set of threads for which processing hardware processes the same instruction in parallel using different input data for the different threads. SIMD groups may also be referred to as SIMT (single-instruction, multiple-thread) groups, single instruction parallel thread (SIPT), or lane-stacked threads. Various types of computer processors may include sets of pipelines configured to execute SIMD instructions. For example, graphics processors often include programmable shader cores that are configured to execute instructions for a set of related threads in a SIMD fashion. Other examples of names that may be used for a SIMD group include: a wavefront, a clique, or a warp. A SIMD group may be a part of a larger threadgroup of threads that execute the same program, which may be broken up into a number of SIMD groups (within which threads may execute in lockstep) based on the parallel processing capabilities of a computer. In some embodiments, each thread is assigned to a hardware pipeline (which may be referred to as a “lane”) that fetches operands for that thread and performs the specified operations in parallel with other pipelines for the set of threads. Note that processors may have a large number of pipelines such that multiple separate SIMD groups may also execute in parallel. In some embodiments, each thread has private operand storage, e.g., in a register file. Thus, a read of a particular register from the register file may provide the version of the register for each thread in a SIMD group.

As used herein, the term “thread” includes its well-understood meaning in the art and refers to sequence of program instructions that can be scheduled for execution independently of other threads. Multiple threads may be included in a SIMD group to execute in lock-step. Multiple threads may be included in a task or process (which may correspond to a computer program). Threads of a given task may or may not share resources such as registers and memory. Thus, context switches may or may not be performed when switching between threads of the same task.

In some embodiments, multiple programmable shader units 160 are included in a GPU. In these embodiments, global control circuitry may assign work to the different sub-portions of the GPU which may in turn assign work to shader cores to be processed by shader pipelines.

TPU 165, in the illustrated embodiment, is configured to schedule fragment processing tasks from programmable shader 160. In some embodiments, TPU 165 is configured to pre-fetch texture data and assign initial colors to fragments for further processing by programmable shader 160 (e.g., via memory interface 180). TPU 165 may be configured to provide fragment components in normalized integer formats or floating-point formats, for example. In some embodiments, TPU 165 is configured to provide fragments in groups of four (a “fragment quad”) in a 2×2 format to be processed by a group of four execution pipelines in programmable shader 160.

Image write buffer 170, in some embodiments, is configured to store processed tiles of an image and may perform operations to a rendered image before it is transferred for display or to memory for storage. In some embodiments, graphics unit 150 is configured to perform tile-based deferred rendering (TBDR). In tile-based rendering, different portions of the screen space (e.g., squares or rectangles of pixels) may be processed separately. Memory interface 180 may facilitate communications with one or more of various memory hierarchies in various embodiments.

As discussed above, graphics processors typically include specialized circuitry configured to perform certain graphics processing operations requested by a computing system. This may include fixed-function vertex processing circuitry, pixel processing circuitry, or texture sampling circuitry, for example. Graphics processors may also execute non-graphics compute tasks that may use GPU shader cores but may not use fixed-function graphics hardware. As one example, machine learning workloads (which may include inference, training, or both) are often assigned to GPUs because of their parallel processing capabilities. Thus, compute kernels executed by the GPU may include program instructions that specify machine learning tasks such as implementing neural network layers or other aspects of machine learning models to be executed by GPU shaders. In some scenarios, non-graphics workloads may also utilize specialized graphics circuitry, e.g., for a different purpose than originally intended.

Further, various circuitry and techniques discussed herein with reference to graphics processors may be implemented in other types of processors in other embodiments. Other types of processors may include general-purpose processors such as CPUs or machine learning or artificial intelligence accelerators with specialized parallel processing capabilities. These other types of processors may not be configured to execute graphics instructions or perform graphics operations. For example, other types of processors may not include fixed-function hardware that is included in typical GPUs. Machine learning accelerators may include specialized hardware for certain operations such as implementing neural network layers or other aspects of machine learning models. Speaking generally, there may be design tradeoffs between the memory requirements, computation capabilities, power consumption, and programmability of machine learning accelerators. Therefore, different implementations may focus on different performance goals. Developers may select from among multiple potential hardware targets for a given machine learning application, e.g., from among generic processors, GPUs, and different specialized machine learning accelerators.

In the illustrated example, graphics unit 150 includes ray intersect accelerator (RIA) 190, which may include hardware configured to perform various ray intersect operations (e.g., for traversal of a bounding volume hierarchy acceleration data structure) in response to instruction(s) executed by programmable shader 160, as described in detail below.

In the illustrated example, graphics unit 150 includes matrix multiply accelerator 195, which may include hardware configured to perform various matrix multiply operations in response to instruction(s) executed by programmable shader 160, as described in detail below.

### Overview of Temperature-Based Threshold Adjustments

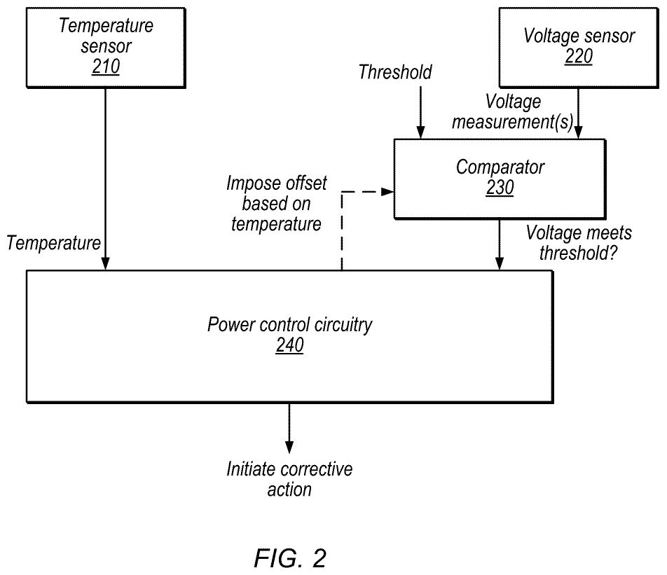

FIG. 2 is a block diagram illustrating power control circuitry configured to impose a temperature-based offset on a comparison operation for power management, according to some embodiments. The disclosed system includes temperature sensor 210, voltage sensor 220, comparator 230, and power control circuitry 240. Generally, in the illustrated example, power control circuitry 240 is configured to impose an offset to operations by comparator 230 based on measurements from temperature sensor 210.

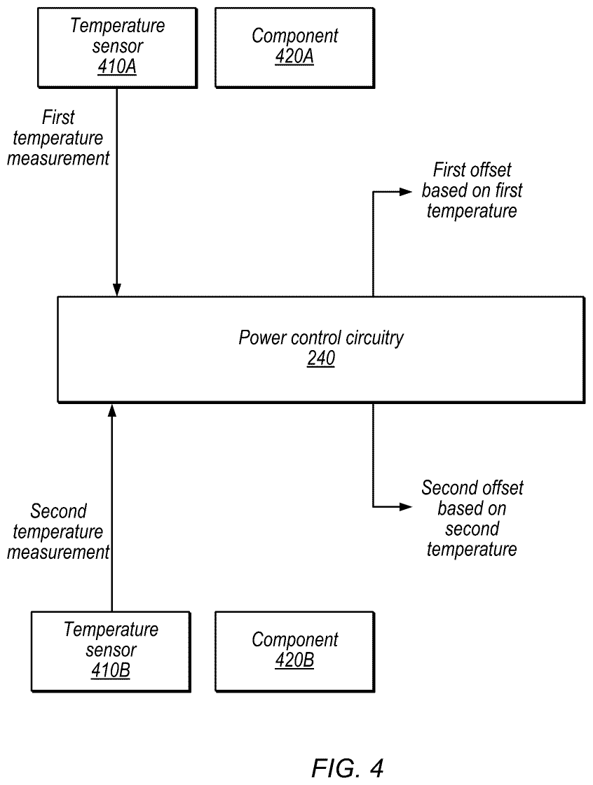

Temperature sensor 210, in some embodiments, is a temperature sensor configured to measure temperature in or proximate to a substrate in which temperature sensor 210 is disposed. For example, temperature sensor 210 may be a thermocouple. The substrate may include a substrate of an IC die. For example, the substrate may be a silicon substrate, a substrate fabricated from III-V semiconductor materials, a substrate fabricated from other semiconductor materials, or combinations thereof. In some embodiments, temperature sensor 210 may be positioned proximate to voltage sensor 220 such that the temperature measurements indicate a temperature of the substrate proximate to voltage sensor 220. Additionally or alternatively, temperature sensor 210 may be positioned proximate to a given IC component of multiple IC components to measure a temperature of the substrate proximate to the given IC component as described in more detail with reference to FIG. 4.

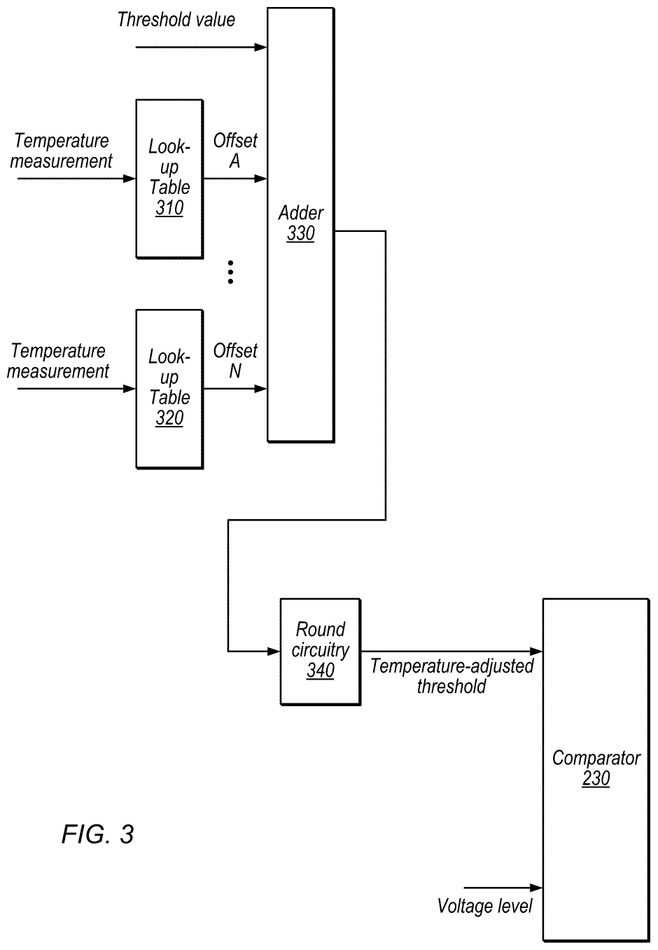

Voltage sensor 220, in some embodiments, is a voltage sensor configured to measure a voltage in or proximate to the substrate in which the voltage sensor 220 is disposed. Voltage sensor 220 may utilize voltage sensitive resistor (VSR) technology (e.g., arranged as a voltage divider or bridge) or any appropriate sensor technology. In some embodiments, a given sensor may be included in an IP block configured to measure multiple values (e.g., a process, voltage, and temperature (PVT) sensor). Comparator 230, in some embodiments, is configured to compare voltage measurement(s) by voltage sensor 220 to a threshold value. Power control circuitry 240, in some embodiments, is configured to control voltage, current, and/or power provided by a power supply to one or more components of the IC die, such as provided to graphics unit 150. For example, power control circuitry 240 may be configured to control performance state, clock frequency, voltage levels, clock gating, etc. of the components. As shown, power control circuitry 240 may impose an offset on the comparison by comparator 230 based on the temperature measured by temperature sensor 210. (While the dashed line is shown as an input to the comparator, this offset may be imposed by adding/subtracting the offset from one of the inputs to comparator 230, as discussed below with reference to FIG. 3).

In particular, power control circuitry 240 may be configured to determine a magnitude of the offset based on a pre-determined effect of the determined temperature on voltage margin parameters for at least a portion of the processor circuitry. For example, power control circuitry 240 may retrieve, from storage circuitry of the IC, the magnitude of the offset from a data structure (e.g., a look-up table) that stores the offset as a function of temperature range, operating state of a given IC component, location of the IC die at which temperature sensor 210 is positioned, or some combination thereof. The pre-determined effect on margin at a given temperature may be determined post-silicon (e.g., after fabrication of one or more chips, using empirical techniques), for example, by testing various workloads at different temperatures and different combinations of components, measuring power supply characteristics (e.g., supply voltage, current draws, etc.) in different scenarios, and recording data relating to different margin parameters for different temperatures (e.g., offsets in the look-up table) to configure desired voltage margin characteristics in different scenarios.

To impose the offset on the indication of the threshold value, power control circuitry 240 adds the offset to (or subtracts the offset from) the threshold value. In some embodiments, the threshold value may be voltage floor or a voltage ceiling. The voltage floor may be a voltage level determined by power control circuitry 240 based on the one or more voltage measurements generated by the voltage sensor 220. The voltage ceiling may be a voltage level determined by power control circuitry 240 based on an operating state of one or more IC components. The offset may correspond to a change in desired voltage margin for a given IC component of multiple IC components at the measured temperature and at a given operating state of the given IC component. The given operating state of the given IC component may correspond to or include a performance state of the component, a power usage level of the component, a type of workload handled by the component, or a combination thereof.

In some embodiments, power control circuitry 240 additionally may be configured to apply an offset to voltage measurements to rectify thermally induced non-linearities in voltage sensor 220. To illustrate, voltage measurements performed by voltage sensor 220 may be inaccurate or imprecise due to thermal effects. Thus, power control circuitry 240 may be configured to apply an offset to one or more voltage measurements to account for these thermally induced non-linearities.

Subsequent to imposition of the offset by power control circuitry 240, comparator 230 may compare the temperature-adjusted threshold value to the supply voltage level. In response to the supply voltage level meeting the temperature-adjusted threshold value, power control circuitry 240 may be configured to initiate one or more corrective actions.

As one example, power control circuitry 240 may be configured to request an increase in supply voltage according to an adaptive voltage margin control scheme, as discussed in the '997 application. As another example, the one or more corrective actions may include adjustable clock and power gating control as described in U.S. Ser. No. 18/759,357 entitled “Adjustable Clock and Power Gating Control,” filed on Jun. 28, 2024, which is incorporated herein by this reference in its entirety. As another example, the one or more corrective actions may include or correspond to limiting a data rate of communications on fabric circuitry of the IC, proportionally to a magnitude of an electrical current threshold violation caused by the IC component as described in U.S. Ser. No. 18/883,268 entitled “Fabric Data Rate Limiting Proportional to Electrical Current Threshold Violations,” filed on Sep. 12, 2024, which is incorporated herein by this reference in its entirety. Further, the one or more corrective actions may include or correspond to limiting a data rate of communication on fabric circuitry of the IC based on quality-of-service (QoS) requirements of data traffic transmitted over various channels of the fabric circuitry as described in U.S. Ser. No. 18/365,783 entitled “Quality-of-Service-Based Fabric Power Management” and filed on Aug. 4, 2023, which is incorporated herein by this reference in its entirety. Additionally or alternatively, to perform the corrective action, power control circuitry 240 may reduce processing tasks performed by a given component (e.g., graphics unit 150) of multiple components of the IC. For instance, to reduce processing tasks performed by the given component of the IC, power control circuitry 240 may instruct other IC components to perform additional tasks that otherwise would have been performed by the given component. Further. other corrective actions may be taken and are not limited to those described herein.

Power control circuitry that adjusts a threshold value based on one or more temperature-adjusted offsets may advantageously improve the accuracy of a comparison operation in which the threshold value is compared with a measured voltage level. A first offset that accounts for thermally induced variation in data processing speed of the components of the IC die, when combined with the threshold value, may advantageously adjust the threshold value to address one thermal effect on IC operation. A second offset that accounts for thermally induced non-linearities in a sensor (e.g., a voltage sensor) may advantageously adjust the threshold value to address another thermal effect on IC operation. Note that, relative to voltage measurements, which vary over a time, the threshold value may remain constant in a particular operating scenario. Accordingly, adjusting the threshold value to account for thermal effects may reduce complexity and power consumption associated with applying the offset relative to applying offset(s) to voltage measurements.

### Example Addition and Rounding Techniques for Applying Offset(s)

FIG. 3 is a block diagram illustrating example application and rounding for multiple different offsets to adjust a threshold value based on temperature, according to some embodiments. Depicted in FIG. 3 are look-up tables 310 and 320, adder 330, round circuitry 340, and comparator 230. Various illustrated circuitry may be included in power control circuitry 240. In the illustrated example, offsets are applied to a threshold value that is an input to a comparison operation. In this example, multiple offsets are added to the threshold value prior to rounding, which may advantageously preserve precision for the temperature-adjusted threshold.

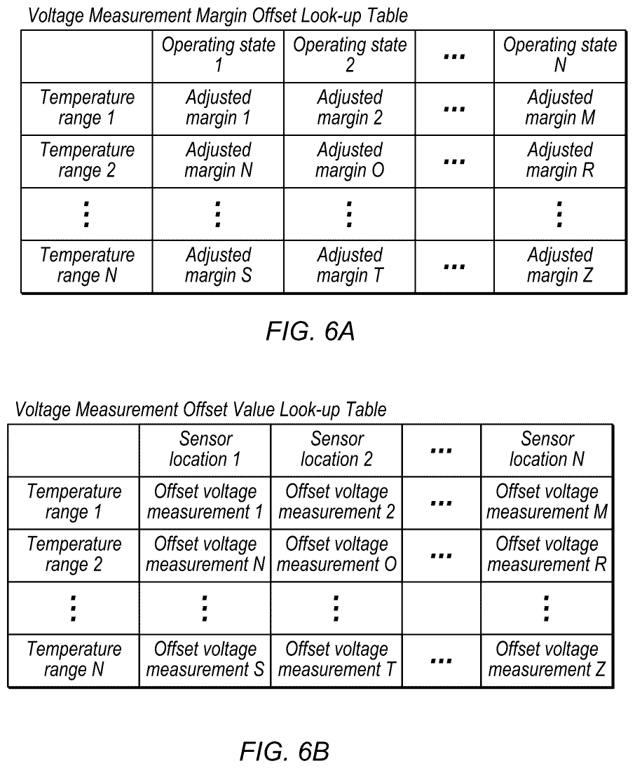

Look-up tables 310 and 320, in some embodiments, are data structures stored in storage circuitry of the IC. As one example, offset A may be a margin-based offset and offset N may be a voltage-sensor-based offset. During operation, power control circuitry accesses look-up tables 310 and 320 based on a temperature measurement. Look-up table 310 may correlate temperature ranges with temperature-adjusted voltage margin values, e.g., corresponding to variation in data processing speed of the components of the IC die. Look-up table 320 may correlate temperature ranges with temperature-adjusted voltage level values, e.g., corresponding to thermally-induced non-linearities in a sensor. Examples of look-up tables 310 and 320 are described in more detail with reference to FIGS. 6A and 6B.

Adder 330, in some embodiments, is configured to add (or subtract) offset A through offset N to (or from) the threshold value to generate a temperature-adjusted threshold value. It is understood that adder 330 may add (or subtract) any number of offsets to or from the threshold value.

Round circuitry 340, in some embodiments, is configured to round the temperature-adjusted offset value up or down, e.g., to a number of bits supported by comparator 230. Note that, to reduce error, one or more of the threshold value and the offsets may include a greater number of bits that the temperature-adjusted threshold generated by round circuitry 340. Summing these values prior to rounding may reduce error in the rounded result, relative to truncating prior to addition of all the inputs. The rounding may include various rounding techniques, including truncation, potentially adjusting the least significant bit based on one or more truncated bits, etc.

Comparator 230, in some embodiments, is configured to compare the temperature-adjusted threshold value with a measured voltage level. In various embodiments, disclosed techniques for generating the temperature-adjusted threshold may improve the accuracy of the comparison.

### Example Embodiment with Distributed/Localized Sensors

FIG. 4 illustrates example control based on localized temperature measurements, according to some embodiments. Various disclosed sensors may be positioned proximate to one or more IC components. Based on the localized temperature/voltage measurements, for example, power control circuitry may generate offsets that account for the temperature of the substrate proximate to the given IC components. This may facilitate adjustments that target voltage margin associated with specific components, adjustments that target certain voltage sensors, or both.

In the illustrated example, the system temperature sensors 410A and 410B and IC component circuitry 420A and 420B. Temperature sensor 410A is proximate to component 420A and measures a temperature of the substrate that is proximate to component 420A, providing a first temperature measurement to power control circuitry 240. Similarly, temperature sensor 410B is proximate to component 420B and measures a temperature of the substrate that is proximate to component 420B, providing a second temperature measurement to power control circuitry 240. Power control circuitry 240, in some embodiments, generates a first offset that is based on the first temperature measurement and a second offset that is based on the second temperature measurement. These localized offsets may be provided to different comparators, to a given comparator at different times, etc.

As an example, component 420A may be a functional IC component (e.g., graphics unit 150), while component 420B may be a voltage sensor (e.g., voltage sensor 220). Accordingly, the first offset generated by power control circuitry 240 based on the first temperature measurement may be operable to adjust a voltage margin of component 420A given an operating state of component 420A. The second offset generated by power control circuitry 240 based on the second temperature measurement may be operable to adjust one or more voltage measurements generated by component 420B to account for non-linearities distorting these measurements due to the temperature of the substrate proximate to component 420B.

Positioning temperature sensors proximate to one or more IC components may advantageously facilitate localized temperature-based threshold adjustments. Since different regions of the IC may experience different temperature levels, generation of offsets based on localized temperature measurements facilitates temperature-based adjustments of a threshold value that accounts for localized temperatures in different regions of the IC.

### Overview of Adaptive Voltage Control

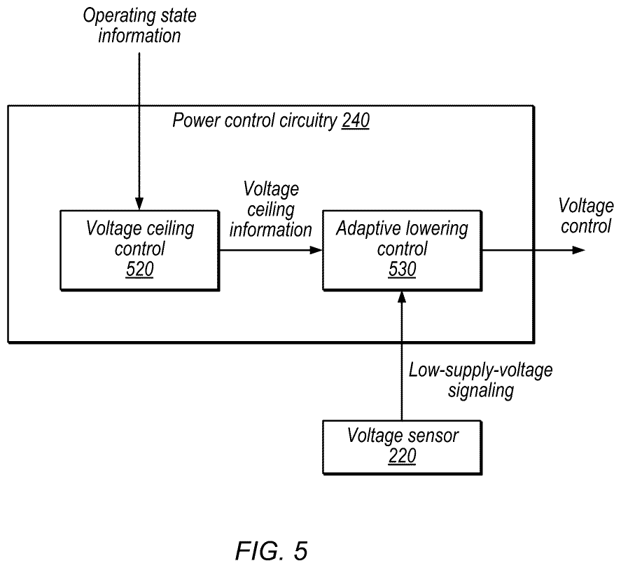

FIG. 5 is a block diagram illustrating example power control circuitry with adaptive margin control, according to some embodiments. In the illustrated example, power control circuitry 240 includes voltage ceiling control circuitry 520 and adaptive lowering control circuitry 530 and is configured to receive signals from voltage sensor 220. Voltage control may request a certain supply voltage from a voltage regulator (not depicted). Note that detailed example embodiments of the system of FIG. 5 are described in the '997 application.

Voltage ceiling control 520, in some embodiments, is configured to receive component state information. This information may indicate the operating state of various components, the power to which is controlled by power control circuitry 240. For example, the operating state information may indicate whether these components are active, current performance state information, gating information, mode information, types of work being performed (e.g., types of instructions being executed), etc.

Based on the operating state information, voltage ceiling control 520 is configured to generate voltage ceiling information for adaptive lowering control 530. The ceiling may be selected to provide voltage margin, e.g., to provide a greater supply voltage than is expected to be used by all the active components. The margining may be limited, however, to reduce overall power consumption.

Voltage sensor 220, in some embodiments, is configured to monitor actual junction voltage during operation of the device and generate voltage measurements. The difference between supply voltage and a measured junction voltage may be referred to as Vdroop, which may vary based on switching activity, leakage, and which components are enabled. In the illustrated embodiment, voltage sensor 220 provides low-supply-voltage signaling to adaptive lowering control 530. This signaling may include raw voltage measurements, filtered voltage measurements, trigger signals based on a detected threshold, etc. In some embodiments, multiple voltage sensors are implemented. Various voltage sensor circuits may be implemented (e.g., resistive type, capacitor type, etc.). Further, voltage sensors may measure voltage indirectly, e.g., based on other measurements such as current.

Adaptive lowering control 530, in some embodiments, is configured to generate voltage control signals based on the voltage ceiling information and based on low-supply-voltage signaling from voltage sensor 220. The voltage control may request a certain supply voltage from a voltage regulator of the SOC.

In some embodiments, power control circuitry 240 is configured to initially control the supply voltage to be at or near the voltage ceiling. Power control circuitry 240 may then incrementally lower the supply voltage, e.g., until triggering a warning associated with voltage sensor 220, at which point it may attempt to maintain the supply voltage near the current level (or slightly increase the supply voltage) until another event occurs. This may advantageously provide voltage margin while still maintaining low power consumption overall.

Note that while voltage control signaling is discussed as an output of power control circuitry 240 in disclosed embodiments, power control circuitry 240 may also trigger various other actions based on voltage comparisons (e.g., P-state changes, clock gating certain circuitry, changing clock frequencies, etc.).

### Example Look-Up Tables

FIG. 6A illustrates an example look-up table with temperature-adjusted voltage margin offset values, according to some embodiments. In the illustrated embodiment, margin-based offsets are organized by operating state (e.g., P-state) and temperature range. In other embodiments, the operating state may indicate, with respect to a given component, the state of a component, power to which is controlled by power control circuitry (e.g., power control circuitry 240). For example and in such an embodiment, for a given component, the operating state may indicate whether the given component is active, current performance state information, gating information, mode information, types of work being performed (e.g., types of instructions being executed), etc.

The given range of temperature values for a lookup table entry may be sized to cover a range of expected drift in temperature over a time interval (e.g., the time interval between comparison operations and potential corrective actions). Based on a temperature measurement received by power control circuitry and a known operating state of an IC component, power control circuitry is configured to identify a temperature-adjusted voltage margin offset value associated with the given IC component based on the information in the look-up table.

FIG. 6B illustrates an example look-up table with temperature-adjusted voltage sensor offset values, according to some embodiments. In the illustrated embodiment, sensor-based offsets are organized by sensor location and temperature range. Accordingly, based on a temperature measurement received by power control circuitry and a known location of a voltage sensor (e.g., voltage sensor 220), power control circuitry is configured to identify a temperature-adjusted offset voltage measurement based on the information in the look-up table.

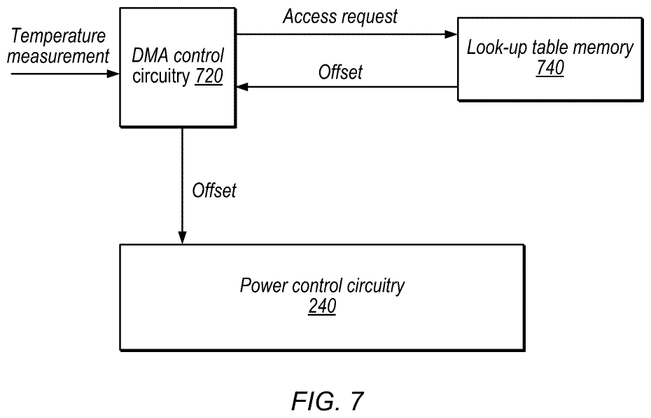

FIG. 7 is a block diagram illustrating example direct memory access (DMA) control circuitry configured to access a lookup table based on a temperature measurement, according to some embodiments. In the illustrated example, the system includes DMA control circuitry 720, look-up table memory 740, and power control circuitry 240.

DMA control circuitry 720, in some embodiments, includes custom circuitry, execute firmware, or a combination thereof configured to perform the functionality described herein. Power control circuitry 240 may cause a temperature sensor to be periodically sampled. In response to receipt of a temperature measurement from a temperature sensor (e.g., temperature sensor 210) that meets a threshold value (e.g., matches or exceeds the threshold value), DMA control circuitry 720 provides an access request to look-up table memory 740. One or more look-up tables stored in look-up table memory 740 may be indexed based on temperature ranges as described with reference to FIGS. 6A and 6B. Accordingly, in response to receipt of the access request, look-up table memory 740 provides, to DMA control circuitry 720, an offset corresponding to the temperature range. The offset may correspond to the offsets described with reference to FIGS. 2-4 and 6A-B. In response to receipt of the offset, DMA control circuitry 720 provides the offset to power control circuitry 240.

Look-up table memory 740, in some embodiments, is static random-access memory (SRAM) of an IC that is configured to store one or more data structures, such as the look-up tables described with reference to FIGS. 6A and 6B.

### Example Method

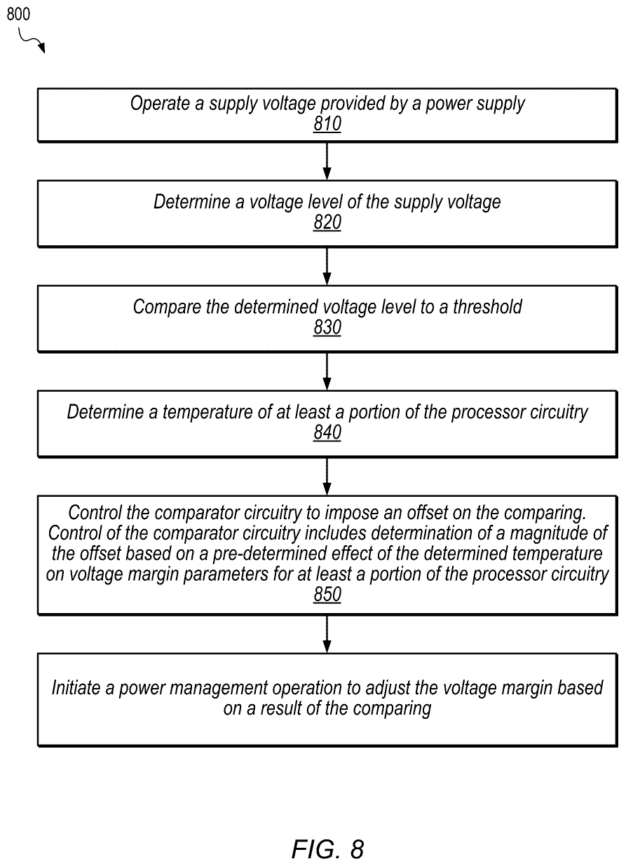

FIG. 8 is a flow diagram illustrating an example method, according to some embodiments. Method 800 may be used in conjunction with any of the computer systems, devices, elements, or components disclosed herein, among other devices. In various embodiments, some of the method elements shown may be performed concurrently, in a different order than shown, or may be omitted. Additional method elements may also be performed if desired.

At 810, in the illustrated embodiment, a computing device (e.g., processor circuitry) operates a supply voltage provided by a power supply.

At 820, in the illustrated embodiment, the computing device (e.g., a voltage sensor) determines a voltage level of the power supply.

At 830, in the illustrated embodiment, the computing device (e.g., comparator circuitry) compares the determined voltage level to a threshold.

At 840, in the illustrated embodiment, the computing device (e.g., a temperature sensor), determines a temperature of at least a portion of the processor circuitry.

At 850, in the illustrated embodiment, the computing device (e.g., a power controller) controls the comparator circuitry to impose an offset on the comparing. To control the comparator circuitry to impose the offset, the computing device determines a magnitude of the offset based on a pre-determined effect of the determined temperature on voltage margin parameters for at least a portion of the processor circuitry.

At 860, in the illustrated embodiment, the computing device (e.g., the power controller), initiates a power power management operation to adjust the voltage margin based on a result of the comparing.

In some embodiments, to control the comparator circuitry to impose the offset, the power control circuitry is further configured to add multiple offsets to the threshold, including the offset based on the pre-determined effect of the determined temperature on voltage margin parameters and an offset that corresponds to an amount of temperature-induced non-linearities in operation of the voltage sensor.

In some embodiments, the power control circuitry is further configured to perform a rounding operation after addition of the multiple offsets to the threshold.

In some embodiments, the computing device further includes multiple voltage sensors disposed at a first set of different locations of the processor circuitry, the multiple voltage sensors including the voltage sensor and multiple temperature sensors disposed proximate to the multiple voltage sensors.

In some embodiments, the power control circuitry is configured to control comparator circuitry for a given voltage sensor based on temperature measurements from one or more proximate temperature sensors.

In some embodiments, the computing device further includes multiple temperature sensors disposed proximate to different components of the processor circuitry.

In some embodiments, the power control circuitry is further configured to determine the offset based on an amount of the voltage margin for a first component of the processor circuitry based on temperature measurements from one or more temperature sensors that are proximate to the first component.

In some embodiments, the power control circuitry is further configured to adaptively adjust the supply voltage, within a performance state of the processor circuitry, between a voltage floor and a voltage ceiling. In some embodiments, the threshold corresponds to at least one of the voltage floor and the voltage ceiling.

In some embodiments, to control the comparator circuitry to impose the offset, the power control circuitry is configured to perform a look-up operation in a data structure in storage circuitry. In some embodiments, the data structure includes multiple entries and a given entry indicates a range of temperature values and an adjustment to the threshold that corresponds to the range.

In some embodiments, a given range of temperature values in an entry of the data structure covers a range of expected drift in temperature over a given time interval during operation of the processor circuitry.

In some embodiments, the power control circuitry is further configured to determine whether to impose the offset based on whether it has detected a threshold change in temperature over time.

In some embodiments, the corrective action includes causing the processor circuitry to reduce distribution of work to one component of multiple components.

### Example Device

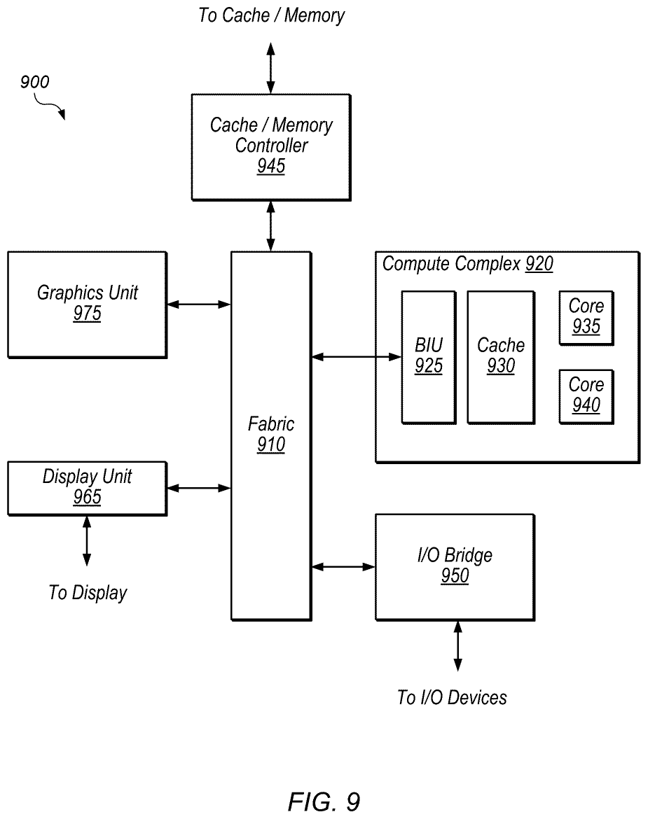

Referring now to FIG. 9, a block diagram illustrating an example embodiment of a device 900 is shown. In some embodiments, elements of device 900 may be included within a system on a chip. In some embodiments, device 900 may be included in a mobile device, which may be battery-powered. Therefore, power consumption by device 900 may be an important design consideration. In the illustrated embodiment, device 900 includes fabric 910, compute complex 920, input/output (I/O) bridge 950, cache/memory controller 945, graphics unit 975, and display unit 965. In some embodiments, device 900 may include other components (not shown) in addition to or in place of the illustrated components, such as video processor encoders and decoders, image processing or recognition elements, computer vision elements, etc.

In some embodiments, disclosed temperature-based threshold adjustment techniques may, for various elements of FIG. 9, advantageously improve performance, reduce power consumption, reduce errors, reduce equipment damage, or some combination thereof, relative to traditional techniques.

Fabric 910 may include various interconnects, buses, MUX's, controllers, etc., and may be configured to facilitate communication between various elements of device 900. In some embodiments, portions of fabric 910 may be configured to implement various different communication protocols. In other embodiments, fabric 910 may implement a single communication protocol and elements coupled to fabric 910 may convert from the single communication protocol to other communication protocols internally.

In the illustrated embodiment, compute complex 920 includes bus interface unit (BIU) 925, cache 930, and cores 935 and 940. In various embodiments, compute complex 920 may include various numbers of processors, processor cores and caches. For example, compute complex 920 may include 1, 2, or 4 processor cores, or any other suitable number. In one embodiment, cache 930 is a set associative L2 cache. In some embodiments, cores 935 and 940 may include internal instruction and data caches. In some embodiments, a coherency unit (not shown) in fabric 910, cache 930, or elsewhere in device 900 may be configured to maintain coherency between various caches of device 900. BIU 925 may be configured to manage communication between compute complex 920 and other elements of device 900. Processor cores such as cores 935 and 940 may be configured to execute instructions of a particular instruction set architecture (ISA) which may include operating system instructions and user application instructions. These instructions may be stored in computer readable medium such as a memory coupled to memory controller 945 discussed below.

As used herein, the term “coupled to” may indicate one or more connections between elements, and a coupling may include intervening elements. For example, in FIG. 9, graphics unit 975 may be described as “coupled to” a memory through fabric 910 and cache/memory controller 945. In contrast, in the illustrated embodiment of FIG. 9, graphics unit 975 is “directly coupled” to fabric 910 because there are no intervening elements.

Cache/memory controller 945 may be configured to manage transfer of data between fabric 910 and one or more caches and memories. For example, cache/memory controller 945 may be coupled to an L3 cache, which may in turn be coupled to a system memory. In other embodiments, cache/memory controller 945 may be directly coupled to a memory. In some embodiments, cache/memory controller 945 may include one or more internal caches. Memory coupled to controller 945 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 945 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 820 to cause the computing device to perform functionality described herein.

Graphics unit 975 may include one or more processors, e.g., one or more graphics processing units (GPUs). Graphics unit 975 may receive graphics-oriented instructions, such as OPENGL®, Metal®, or DIRECT3D® instructions, for example. Graphics unit 975 may execute specialized GPU instructions or perform other operations based on the received graphics-oriented instructions. Graphics unit 975 may generally be configured to process large blocks of data in parallel and may build images in a frame buffer for output to a display, which may be included in the device or may be a separate device. Graphics unit 975 may include transform, lighting, triangle, and rendering engines in one or more graphics processing pipelines. Graphics unit 975 may output pixel information for display images. Graphics unit 975, in various embodiments, may include programmable shader circuitry which may include highly parallel execution cores configured to execute graphics programs, which may include pixel tasks, vertex tasks, and compute tasks (which may or may not be graphics-related).

Display unit 965 may be configured to read data from a frame buffer and provide a stream of pixel values for display. Display unit 965 may be configured as a display pipeline in some embodiments. Additionally, display unit 965 may be configured to blend multiple frames to produce an output frame. Further, display unit 965 may include one or more interfaces (e.g., MIPI® or embedded display port (eDP)) for coupling to a user display (e.g., a touchscreen or an external display).

I/O bridge 950 may include various elements configured to implement: universal serial bus (USB) communications, security, audio, and low-power always-on functionality, for example. I/O bridge 950 may also include interfaces such as pulse-width modulation (PWM), general-purpose input/output (GPIO), serial peripheral interface (SPI), and inter-integrated circuit (I2C), for example. Various types of peripherals and devices may be coupled to device 900 via I/O bridge 950.

In some embodiments, device 900 includes network interface circuitry (not explicitly shown), which may be connected to fabric 910 or I/O bridge 950. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 900 with connectivity to various types of other devices and networks.

### Example Applications

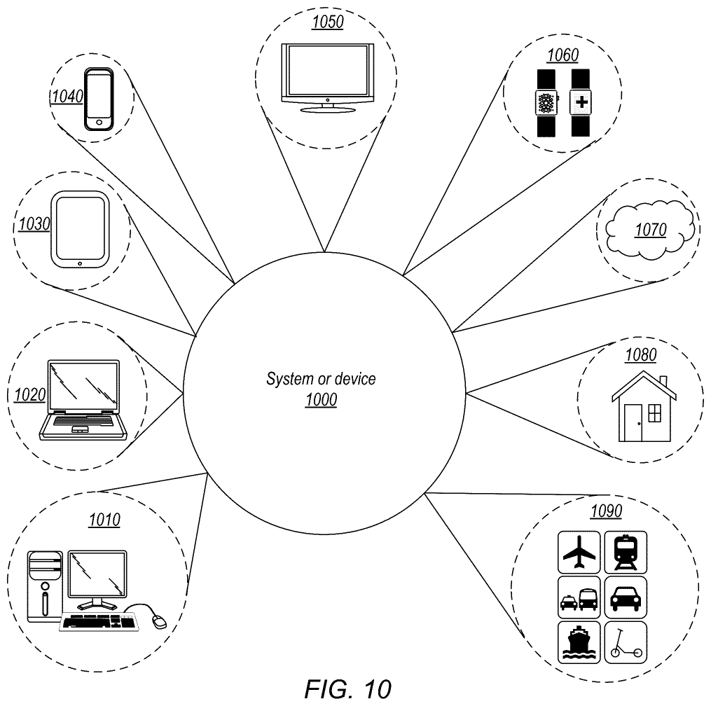

Turning now to FIG. 10, various types of systems that may include any of the circuits, devices, or system discussed above. System or device 1000, which may incorporate or otherwise utilize one or more of the techniques described herein, may be utilized in a wide range of areas. For example, system or device 1000 may be utilized as part of the hardware of systems such as a desktop computer 1010, laptop computer 1020, tablet computer 1030, cellular or mobile phone 1040, or television 1050 (or set-top box coupled to a television).

Similarly, disclosed elements may be utilized in a wearable device 1060, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1000 may also be used in various other contexts. For example, system or device 1000 may be utilized in the context of a server computer system, such as a dedicated server or on shared hardware that implements a cloud-based service 1070. Still further, system or device 1000 may be implemented in a wide range of specialized everyday devices, including devices 1080 commonly found in the home such as refrigerators, thermostats, security cameras, etc. The interconnection of such devices is often referred to as the “Internet of Things” (IoT). Elements may also be implemented in various modes of transportation. For example, system or device 1000 could be employed in the control systems, guidance systems, entertainment systems, etc. of various types of vehicles 1090.

The applications illustrated in FIG. 10 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

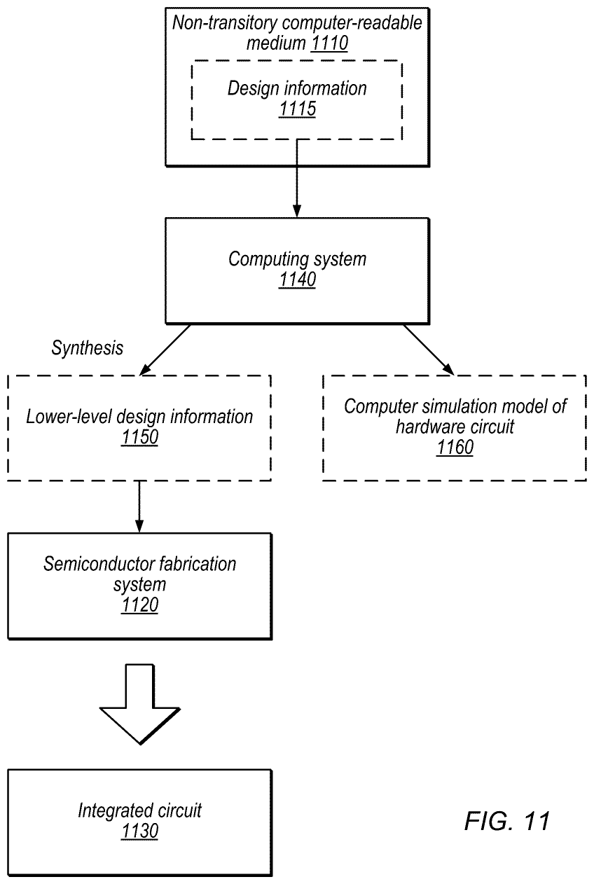

FIG. 11 is a block diagram illustrating an example non-transitory computer-readable storage medium that stores circuit design information, according to some embodiments. In the illustrated embodiment, computing system 1140 is configured to process the design information. This may include executing instructions included in the design information, interpreting instructions included in the design information, compiling, transforming, or otherwise updating the design information, etc. Therefore, the design information controls computing system 1140 (e.g., by programming computing system 1140) to perform various operations discussed below, in some embodiments.

In the illustrated example, computing system 1140 processes the design information to generate both a computer simulation model of a hardware circuit 1160 and lower-level design information 1150. In other embodiments, computing system 1140 may generate only one of these outputs, may generate other outputs based on the design information, or both. Regarding the computing simulation, computing system 1140 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 1140 also processes the design information to generate lower-level design information 1150 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 1150 (potentially among other inputs), semiconductor fabrication system 1120 is configured to fabricate an integrated circuit 1130 (which may correspond to functionality of the simulation model 1160). Note that computing system 1140 may generate different simulation models based on design information at various levels of description, including information 1150, 1115, and so on. The data representing design information 1150 and model 1160 may be stored on medium 1110 or on one or more other media.

In some embodiments, the lower-level design information 1150 controls (e.g., programs) the semiconductor fabrication system 1120 to fabricate the integrated circuit 1130. Thus, when processed by the fabrication system, the design information may program the fabrication system to fabricate a circuit that includes various circuitry disclosed herein.

Non-transitory computer-readable storage medium 1110, may comprise any of various appropriate types of memory devices or storage devices. Non-transitory computer-readable storage medium 1110 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 1110 may include other types of non-transitory memory as well or combinations thereof. Accordingly, non-transitory computer-readable storage medium 1110 may include two or more memory media; such media may reside in different locations—for example, in different computer systems that are connected over a network.

Design information 1115 may be specified using any of various appropriate computer languages, including hardware description languages such as, without limitation: VHDL, Verilog, SystemC, SystemVerilog, RHDL, M, MyHDL, etc. The format of various design information may be recognized by one or more applications executed by computing system 1140, semiconductor fabrication system 1120, or both. In some embodiments, design information may also include one or more cell libraries that specify the synthesis, layout, or both of integrated circuit 1130. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 1130 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1120 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1120 may also be configured to perform various testing of fabricated circuits for correct operation.

In various embodiments, integrated circuit 1130 and model 1160 are configured to operate according to a circuit design specified by design information 1115, which may include performing any of the functionality described herein. For example, integrated circuit 1130 may include any of various elements shown in at least FIGS. 1B, 2-5, 7, or any combination thereof. Further, integrated circuit 1130 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 1120 to fabricate integrated circuit 1130.

The concept of “execution” is broad and may refer to 1) processing of an instruction throughout an execution pipeline (e.g., through fetch, decode, execute, and retire stages) and 2) processing of an instruction at an execution unit or execution subsystem of such a pipeline (e.g., an integer execution unit or a load-store unit). The latter meaning may also be referred to as “performing” the instruction. Thus, “performing” an add instruction refers to adding two operands to produce a result, which may, in some embodiments, be accomplished by a circuit at an execute stage of a pipeline (e.g., an execution unit). Conversely, “executing” the add instruction may refer to the entirety of operations that occur throughout the pipeline as a result of the add instruction. Similarly, “performing” a “load” instruction may include retrieving a value (e.g., from a cache, memory, or stored result of another instruction) and storing the retrieved value into a register or other location.

As used herein the terms “complete” and “completion” in the context of an instruction refer to commitment of the instruction's result(s) to the architectural state of a processor or processing element. For example, completion of an add instruction includes writing the result of the add instruction to a destination register. Similarly, completion of a load instruction includes writing a value (e.g., a value retrieved from a cache or memory) to a destination register or a representation thereof.

The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

Multiple “kicks” may be executed to render a frame of graphics data. In some embodiments, a kick is a unit of work from a single context that may include multiple threads to be executed (and may potentially include other types of graphics work that is not performed by a shader). A kick may not provide any assurances regarding memory synchronization among threads (other than specified by the threads themselves), concurrency among threads, or launch order among threads. In some embodiments, a kick may be identified as dependent on the results of another kick, which may allow memory synchronization without requiring hardware memory coherency support. Typically, graphics firmware or hardware programs configuration registers for each kick before sending the work to the pipeline for processing. Often, once a kick has started, it does not access a memory hierarchy past a certain level until the kick is finished (at which point results may be written to another level in the hierarchy). Information for a given kick may include state information, location of shader program(s) to execute, buffer information, location of texture data, available address spaces, etc. that are needed to complete the corresponding graphics operations. Graphics firmware or hardware may schedule kicks and detect an interrupt when a kick is complete, for example. In some embodiments, portions of a graphics unit are configured to work on a single kick at a time. This set of resources may be referred to as a “kickslot.” Thus, in some embodiments, any data that is needed for a given kick is read from memory that is shared among multiple processing elements at the beginning of the kick and results are written back to shared memory at the end of the kick. Therefore, other hardware may not see the results of the kick until completion of the kick, at which point the results are available in shared memory and can be accessed by other kicks (including kicks from other data masters). A kick may include a set of one or more rendering commands, which may include a command to draw procedural geometry, a command to set a shadow sampling method, a command to draw meshes, a command to retrieve a texture, a command to perform generation computation, etc. A kick may be executed at one of various stages during the rendering of a frame. Examples of rendering stages include, without limitation: camera rendering, light rendering, projection, texturing, fragment shading, etc. Kicks may be scheduled for compute work, vertex work, or pixel work, for example.

The various techniques described herein may be performed by one or more computer programs. The term “program” is to be construed broadly to cover a sequence of instructions in a programming language that a computing device can execute. These programs may be written in any suitable computer language, including lower-level languages such as assembly and higher-level languages such as Python. The program may be written in a compiled language such as C or C++, or an interpreted language such as JavaScript.

Program instructions may be stored on a “computer-readable storage medium” or a “computer-readable medium” in order to facilitate execution of the program instructions by a computer system. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more. ” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or”is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S. C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

1. An apparatus, comprising:
processor circuitry configured to operate based on a supply voltage provided by a power supply;
a voltage sensor configured to determine a voltage level of the supply voltage;
comparator circuitry configured to perform a comparison operation that compares the determined voltage level to a threshold;
a temperature sensor configured to determine a temperature of at least a portion of the processor circuitry; and
power control circuitry configured to:
initiate a power management operation to adjust voltage margin based on a result of the comparison operation; and
control the comparator circuitry to impose an offset on the comparison operation, wherein the power control circuitry is further configured to determine a magnitude of the offset based on a pre-determined effect of the determined temperature on voltage margin parameters for at least a portion of the processor circuitry.

2. The apparatus of claim 1, wherein, to control the comparator circuitry to impose the offset, the power control circuitry is further configured to add multiple offsets to the threshold, including the offset based on the pre-determined effect of the determined temperature on voltage margin parameters and an offset that corresponds to an amount of temperature-induced non-linearities in operation of the voltage sensor.

3. The apparatus of claim 2, wherein the power control circuitry is further configured to:
perform a rounding operation after addition of the multiple offsets to the threshold.

4. The apparatus of claim 1, further comprising:
multiple voltage sensors disposed at a first set of different locations of the processor circuitry, the multiple voltage sensors including the voltage sensor; and
multiple temperature sensors disposed proximate to the multiple voltage sensors;
wherein the power control circuitry is further configured to control comparator circuitry for a given voltage sensor based on temperature measurements from one or more proximate temperature sensors.

5. The apparatus of claim 1, further comprising:
multiple temperature sensors disposed proximate to different components of the processor circuitry;
wherein the power control circuitry is further configured to determine the offset based on an amount of the voltage margin for a first component of the processor circuitry based on temperature measurements from one or more temperature sensors that are proximate to the first component.

6. The apparatus of claim 1, wherein the power control circuitry is further configured to:
adaptively adjust the supply voltage, within a performance state of the processor circuitry, between a voltage floor and a voltage ceiling, wherein the threshold corresponds to at least one of the voltage floor and the voltage ceiling.

7. The apparatus of claim 1, wherein, to control the comparator circuitry to impose the offset, the power control circuitry is configured to perform a look-up operation in a data structure in storage circuitry, wherein the data structure includes multiple entries and a given entry indicates a range of temperature values and an adjustment to the threshold that corresponds to the range.

8. The apparatus of claim 7, wherein a given range of temperature values in an entry of the data structure covers a range of expected drift in temperature over a given time interval during operation of the processor circuitry.

9. The apparatus of claim 1, wherein the power control circuitry is further configured to determine whether to impose the offset based on whether it has detected a threshold change in temperature over time.

10. The apparatus of claim 1, wherein the power management operation includes causing the processor circuitry to reduce distribution of work to one component of multiple components.

11. A method, comprising:
operating, by processor circuitry, based on a supply voltage provided by a power supply;
determining, by a voltage sensor, a voltage level of the supply voltage;
comparing, by comparator circuitry, the determined voltage level to a threshold;
determining, by a temperature sensor, a temperature of at least a portion of the processor circuitry;
controlling, by a power controller, the comparator circuitry to impose an offset on the comparing, wherein controlling the comparator circuitry includes determining a magnitude of the offset based on a pre-determined effect of the determined temperature on voltage margin parameters for at least a portion of the processor circuitry; and
initiating, by the power controller, a power management operation to adjust a voltage margin based on a result of the comparing.

12. The method of claim 11, wherein controlling the comparator circuitry to impose the offset includes adding multiple offsets to the threshold, wherein the multiple offsets include the offset based on the pre-determined effect of the determined temperature on voltage margin parameters and an offset that corresponds to an amount of temperature-induced non-linearities in operation of the voltage sensor.

13. The method of claim 11, wherein controlling the comparator circuitry includes controlling the comparator circuitry for a given voltage sensor based on temperature measurements from one or more temperature sensors that are proximate to the given voltage sensor, the given voltage sensor included among multiple voltage sensors disposed at a first set of different locations of the processor circuitry, the multiple voltage sensors including the voltage sensor.

14. The method of claim 11, further comprising determining whether to impose the offset based on whether the power controller has detected a threshold change in temperature over a given time period.

15. The method of claim 11, further comprising:
adaptively adjusting the supply voltage, within a performance state of the processor circuitry, between a voltage floor and a voltage ceiling, wherein the threshold corresponds to at least one of the voltage floor and the voltage ceiling.

16. A non-transitory computer readable storage medium having stored thereon design information that specifies a design of at least a portion of a hardware integrated circuit in a format recognized by a semiconductor fabrication system that is configured to use the design information to produce the circuit according to the design, including:
processor circuitry configured to operate based on a supply voltage provided by a power supply;
a voltage sensor configured to determine a voltage level of the supply voltage;
comparator circuitry configured to perform a comparison operation that compares the determined voltage level to a threshold;
a temperature sensor configured to determine a temperature of at least a portion of the processor circuitry; and
power control circuitry configured to:
initiate a power management operation to adjust voltage margin based on a result of the comparison operation; and
control the comparator circuitry to impose an offset on the comparison operation, wherein the power control circuitry is further configured to determine a magnitude of the offset based on a pre-determined effect of the determined temperature on voltage margin parameters for at least a portion of the processor circuitry.

17. The non-transitory computer readable storage medium of claim 16, wherein, to control the comparator circuitry to impose the offset, the power control circuitry is further configured to add multiple offsets to the threshold, including the offset based on the pre-determined effect of the determined temperature on voltage margin parameters and an offset that corresponds to an amount of temperature-induced non-linearities in operation of the voltage sensor.

18. The non-transitory computer readable storage medium of claim 16, wherein the design information further specifies that the circuit includes:
multiple voltage sensors disposed at a first set of different locations of the processor circuitry, the multiple voltage sensors including the voltage sensor; and
multiple temperature sensors disposed proximate to the multiple voltage sensors;
wherein the power control circuitry is configured to control comparator circuitry for a given voltage sensor based on temperature measurements from one or more proximate temperature sensors.

19. The non-transitory computer readable storage medium of claim 16, wherein the design information further specifies that the circuit includes:
multiple temperature sensors disposed proximate to different components of the processor circuitry;
wherein the power control circuitry is configured to determine the offset based on an amount of the voltage margin for a first component of the processor circuitry based on temperature measurements from one or more temperature sensors that are proximate to the first component.

20. The non-transitory computer readable storage medium of claim 16, wherein the power control circuitry is further configured to:
adaptively adjust the supply voltage, within a performance state of the processor circuitry, between a voltage floor and a voltage ceiling, wherein the threshold corresponds to at least one of the voltage floor and the voltage ceiling.
